(19) United States
(12) Patent Application Publication
(10) Pub. No.: US 2016/0061070 A1
(43) Pub. Date: Mar. 3, 2016

(54) Four-stroke Engine

(71) Applicant: Taizhou Qinglong Machinery & Electric Co., Ltd., Taizhou (CN)

(72) Inventor: Daobing Huang, Taizhou (CN)

(73) Assignee: TAIZHOU QINGLONG MACHINERY & ELECTRIC CO., LTD.

(21) Appl. No.: 14/494,551

(22) Filed: Sep. 23, 2014

(30) Foreign Application Priority Data
Aug. 26, 2014 (CN) 201410425584.7

(51) Int. Cl. F01M 1/04; F02B 75/02; F02B 63/02; F02M 17/14

(52) U.S. Cl. CPC F01M 1/04; F02M 17/14; F02B 75/02; F02B 63/02

(57) ABSTRACT

The invention relates to a 360° reversible four-stroke engine, including a cylinder, a plunger, a crankshaft component and a carburetor, wherein the carburetor is used for providing mixed oil and gas to an intake passage, the mixed oil and gas is communicated to an intake valve component in a rocker chamber through the intake passage, and the mixed oil and gas is communicated to an intake valve component in a rocker chamber through the intake passage; said intake passage is setup with a bypass connected to a crankshaft chamber, the bypass is a mixed oil and gas lubrication passage, the lower portion of the crankshaft chamber is connected to an one-way valve chamber, the one-way valve chamber is communicated with a cam chamber and is setup with an one-way valve therein which opens upon positive pressure of the crankshaft chamber and closes upon negative pressure of the crankshaft chamber.

### CROSS-REFERENCE TO RELATED APPLICATIONS

This application claims the benefit of Chinese Patent Application No. 201410425584.7 filed on Aug. 26, 2014, the content of which is hereby incorporated by reference.

### TECHNICAL FIELD

The invention belongs to the field of small engines, in particular relates to a 360° reversible four-stroke engine used for brush saws, chain saws, blower-vacuum and other portable tools.

### BACKGROUND

At present, small engines are widely used at home and abroad, but many working conditions requires 360° reversible engines which can work normally in any position, such as hedge shear, chain saw and other portable tools. Now small engines used by these portable tools are mostly two-stroke engines, but the two-stroke engines can not meet increasingly stringent standards due to its high emission, high oil consumption and high noise as the requirements of environmental protection and energy saving are becoming more and more strict at home and abroad. It is hard to solve problems of high emission, high oil consumption and high noise caused by structure and operating principle of two-stroke engines.

### SUMMARY

An object of this invention is to provide a small four-stroke reversible engine with low emission, low oil consumption and low noise, which solves the problems of high emission, high oil consumption and high noise of the small two-stroke reversible engine.

The object of this invention is realized by:

A four-stroke engine, including

a cylinder, setup with a main chamber therein, wherein the main chamber includes a combustion chamber and a crankshaft chamber connected to each other; said combustion chamber is setup with an intake passage and an exhaust passage, an intake valve component for controlling communication or cut-off of its gas path is set at the joint where said intake passage and said combustion chamber are connected, and an exhaust valve component for controlling communication or cut-off of its gas path is set at the joint where said exhaust passage and said combustion chamber are connected; a plunger is mounted in said combustion chamber, a crankshaft component is mounted in said crankshaft chamber, said plunger is connected with the crankshaft component and drive it to move, and said crankshaft component outputs torque externally;

an one-way valve chamber, which is set under said crankshaft chamber and connected with the crankshaft chamber, wherein an one-way valve is set between said crankshaft chamber and said one-way valve chamber, and said one-way valve opens upon positive pressure of the crankshaft chamber and closes upon negative pressure of the crankshaft chamber;

a carburetor, which is used for providing mixed oil and gas to the combustion chamber, wherein said mixed oil and gas goes into the combustion chamber through the intake passage;

an ignition unit, which is used for igniting the mixed oil and gas in the combustion chamber, wherein the ignition unit is mounted on the cylinder;

a rocker chamber set outside said cylinder, which accommodates said intake valve component, exhaust valve component as well as the upper rocker;

a cam chamber set outside said cylinder, wherein a timing gear and a cam gear component are set therein; said timing gear is linked with the crankshaft component and then drives the cam gear component, said cam gear component drives said intake valve component and said exhaust valve component through the upper rocker;

a mixed oil and gas lubrication passage set between said intake passage and said crankshaft chamber, wherein the mixed oil and gas lubrication passage opens upon negative pressure of the crankshaft chamber and closes upon positive pressure; said one-way valve chamber is communicated with said cam chamber, said cam chamber is communicated with the rocker chamber, said rocker chamber is communicated with the intake passage through the oil and gas passage;

more than one mixed oil and gas lubrication passage is set, and ports of the mixed oil and gas lubrication passages are connected to said crankshaft chamber; when said plunger moves up and down, the lower sidewall of the plunger blocks or opens said mixed oil and gas lubrication passages.

Said one-way valve chamber is set under the crankshaft chamber and more than one one-way valve is set in said one-way valve chamber.

Said mixed oil and gas is gas mixture of air, fuel and lubricating oil.

The invention has prominent and beneficial technical effects compared to the prior art:

The invention employs a small four-stroke reversible engine to provide power for portable tools, compared to two-stroke reversible engines in the prior art, which has advantages of low emission, low oil consumption, and low noise, are particularly suitable for handheld portable tools, can greatly improve working conditions of operators and can reduce 30-40% oil consumption.

The invention employs mixed oil and gas to lubricate various parts, so as to lower the temperature of the crankcase, and the lubrication mode of the invention is unidirectional, fresh mixed oil and gas enters the crankshaft chamber constantly, so engine oil would not undergo deterioration.

### BRIEF DESCRIPTION OF THE DRAWING

FIG. 1 is a structural representation of a small four-stroke engine.

FIG. 2 is a left section view of the engine as shown.

FIG. 3 is a diagram of operating principle of lubrication of the small four-stroke engine of the invention.

1—carburetor; 2—intake tube; 3—intake passage; 4—intake valve component; 5—rocker chamber; 6—exhaust valve component; 7—exhaust passage; 8—cylinder; 9—combustion chamber; 10—crankshaft chamber; 11—case; 12—one-way valve chamber; 13—mixed oil and gas lubrication passage; 14—cam chamber; 15—cam gear component; 16—timing gear; 17—oil and gas passage; 18—upper rocker; 19—plunger; 20—crankshaft component; 21—one-way valve.

### DETAILED DESCRIPTION

The invention will be further described by way of specific embodiments in conjunction with the accompanying drawings.

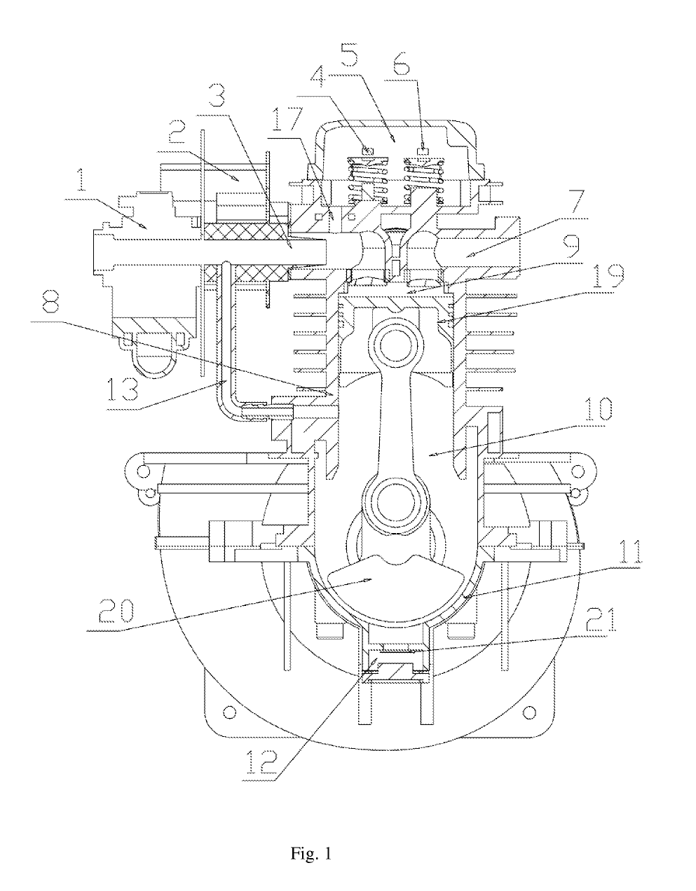

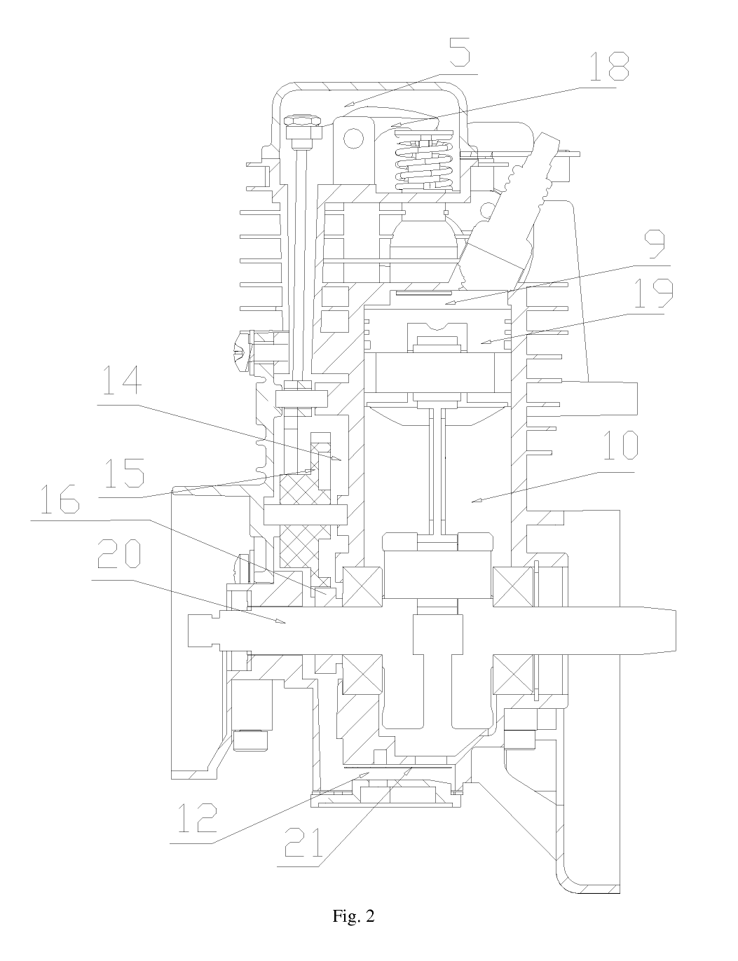

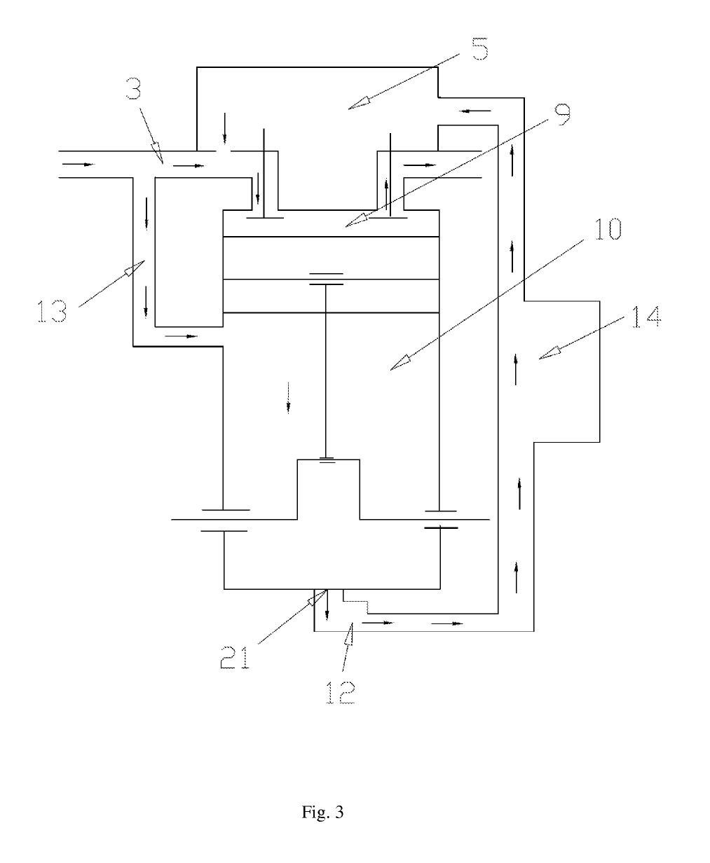

As shown in FIG. 1-3,

a four-stroke engine includes:
a cylinder 8, setup with a main chamber therein, wherein the main chamber includes a combustion chamber 9 and a crankshaft chamber 10 connected to each other; said combustion chamber is setup with an intake passage 3 and an exhaust passage 7, an intake valve component 4 for controlling communication or cut-off of its gas path is set at the joint where said intake passage 3 and said combustion chamber 9 are connected; an exhaust valve component 6 for controlling communication or cut-off of its gas path is set at the joint where said exhaust passage 7 and said combustion chamber 9 are connected; a plunger 19 is mounted in said combustion chamber 9, a crankshaft component 20 is mounted in said crankshaft chamber 10, the lower portion of the plunger 19 is connected with the crankshaft component 20 and drive it to move; the crankshaft component 20 outputs torque externally;

an one-way valve chamber 12, which is set under said crankshaft chamber 10 and connected with the crankshaft chamber 10, wherein an one-way valve 21 is set between said crankshaft chamber 10 and said one-way valve chamber 12, and said one-way valve 21 opens upon positive pressure of the crankshaft chamber and closes upon negative pressure of the crankshaft chamber;

a carburetor 1, which is used for providing mixed oil and gas to the intake passage 3, wherein the mixed oil and gas is led to intake valve component 4 in the rocker chamber 5 through the intake passage 3, and the mixed oil and gas refers to gas mixture of air, fuel and lubricating oil;

an ignition unit, which is used for igniting the mixed oil and gas in the combustion chamber 9, wherein the ignition unit is mounted on the cylinder 8;

a rocker chamber 5 (the rocker chamber 5 is formed by end covers mounted on the cylinder) set outside said cylinder 8, which accommodates said intake valve component 4, exhaust valve component 6 as well as the upper rocker 18;

a cam chamber 14 set outside said cylinder 8, which accommodates a timing gear and a cam gear component; wherein said timing gear 16 is linked with the crankshaft component 20 and then drives the cam gear component 15, the cam gear component 15 drives said intake valve component 4 and said exhaust valve component 6 through the upper rocker 18;

a bypass set for said intake passage 3 and connected to the crankshaft chamber 10, wherein the bypass is a mixed oil and gas lubrication passage 13, the mixed oil and gas lubrication passage 13 opens upon negative pressure of the crankshaft chamber and closes upon positive pressure; said one-way valve chamber 12 is communicated with said cam chamber 14, said cam chamber 14 is communicated with the rocker chamber 5, said rocker chamber 5 is communicated with the intake passage 3 through the oil and gas passage 17.

Preferably, more than one mixed oil and gas lubrication passage 13 is set, and ports of the mixed oil and gas lubrication passages are connected to said crankshaft chamber 10; when said plunger 19 moves up and down, the lower sidewall of the plunger 19 blocks or opens said mixed oil and gas lubrication passages 13.

Preferably, said one-way valve chamber 12 is set under the crankshaft chamber 10 and more than one one-way valve is set in said one-way valve chamber 12.

Said mixed oil and gas is gas mixture of air, fuel and lubricating oil.

During intake stroke, the upper rocker 18 controls the intake valve component 4 to open and the exhaust valve component 6 to close, the plunger 19 moves downwards and closes the mixed oil and gas lubrication passage 13, the mixed oil and gas in the intake passage 3 is intake to the combustion chamber 9, at this point, the crankshaft chamber 10 has positive pressure, the mixed oil and gas in the crankshaft chamber 10 is compressed into the one-way valve chamber 12 and then into the rocker chamber 5 through the cam chamber 14, and the cam gear component 15 in the cam chamber 14, the upper rocker 18 in the rocker chamber 5 and other moving parts are lubricated, and the mixed oil and gas in the rocker chamber 5 goes through the oil and gas passage 17 into the intake passage 3 and then into the combustion chamber for combustion.

During compression stroke, the intake valve component 4 and the exhaust valve component 6 close, the plunger 19 moves upwards and compresses the mixed oil and gas entering the combustion chamber 9, the mixed oil and gas lubrication passage 13 is communicated, at this point, the crankshaft chamber 10 forms negative pressure inside and intakes the mixed oil and gas in the mixed oil and gas lubrication passage 13 to the crankshaft chamber 10 for lubricating the crankshaft component 20 and other moving parts.

During power stroke, the intake valve component 4 closes, the exhaust valve component 6 closes, the ignition unit (i.e., spark plug) ignites the compressed mixed oil and gas, the burning gas expands rapidly to push the plunger 19 to move downwards so as to convert internal energy to mechanical energy, the plunger 19 closes the mixed oil lubrication passage again, the crankshaft chamber 10 has positive pressure at this point and compresses the mixed oil and gas from the crankshaft chamber 10 to the one-way valve chamber 12, and then into the rocker chamber 5 through the cam chamber 14 for lubricating the cam gear component 15 and other moving parts.

During the exhaust stroke, the plunger 19 moves upwards, the intake valve component 4 closes, the exhaust valve component 6 opens, meanwhile the crankshaft chamber 10 forms negative pressure inside again, opens the mixed oil lubrication passage and intakes the mixed oil and gas to the crankshaft chamber 10 for lubricating the crankshaft and other moving parts.

The invention employs a small four-stroke reversible engine to provide power for portable tools, compared to two-stroke reversible engines in the prior art, which has advantages of low emission, low oil consumption, and low noise, are particularly suitable for handheld portable tools, can greatly improve working conditions of operators and can reduce 30-40% oil consumption.

The invention employs mixed oil and gas to lubricate various parts, so as to lower the temperature of the crankcase, and the lubrication mode of the invention is unidirectional, fresh mixed oil and gas enters the crankshaft chamber 10 constantly, so engine oil would not undergo deterioration.

By the invention, the temperature of the crankcase can be controlled around 90° C. and the temperature of the cam chamber can be controlled around 95° C. By way of commercially available STIHL as an example, the temperature of its crankcase is usually 115° C. and the temperature of its cam chamber is usually 125° C.

Examples above are only preferred examples of the invention, but does not limit the scope of the invention hereby, so equivalent variations made according to structures, shapes and principles of the invention should be encompassed by the scope of the invention.

1. A four-stroke engine, characterized by including
a cylinder, setup with a main chamber therein, wherein the main chamber includes a combustion chamber and a crankshaft chamber connected to each other; said combustion chamber is setup with an intake passage and an exhaust passage, an intake valve component for controlling communication or cut-off of its gas path is set at the joint where said intake passage and said combustion chamber are connected, and an exhaust valve component for controlling communication or cut-off of its gas path is set at the joint where said exhaust passage and said combustion chamber are connected; a plunger is mounted in said combustion chamber, a crankshaft component is mounted in said crankshaft chamber, said plunger is connected with the crankshaft component and drive it to move, and said crankshaft component outputs torque externally;
an one-way valve chamber, which is set under said crankshaft chamber and connected with the crankshaft chamber, wherein an one-way valve is set between said crankshaft chamber and said one-way valve chamber, and said one-way valve opens upon positive pressure of the crankshaft chamber and closes upon negative pressure of the crankshaft chamber;
a carburetor, which is used for providing mixed oil and gas to the combustion chamber, wherein said mixed oil and gas goes into the combustion chamber through the intake passage;
an ignition unit, which is used for igniting the mixed oil and gas in the combustion chamber, wherein the ignition unit is mounted on the cylinder;
a rocker chamber set outside said cylinder, which accommodates said intake valve component, exhaust valve component as well as the upper rocker;
a cam chamber set outside said cylinder, wherein a timing gear and a cam gear component are set therein; said timing gear is linked with the crankshaft component and then drives the cam gear component, said cam gear component drives said intake valve component and said exhaust valve component through the upper rocker;
a mixed oil and gas lubrication passage set between said intake passage and said crankshaft chamber, wherein the mixed oil and gas lubrication passage opens upon negative pressure of the crankshaft chamber and closes upon positive pressure; said one-way valve chamber is communicated with said cam chamber, said cam chamber is communicated with the rocker chamber, said rocker chamber is communicated with the intake passage through the oil and gas passage.

2. The four-stroke engine according to claim 1, characterized in that, more than one mixed oil and gas lubrication passage is set, and ports of the mixed oil and gas lubrication passages are connected to said crankshaft chamber; when said plunger moves up and down, the lower sidewall of the plunger blocks or opens said mixed oil and gas lubrication passages.

3. The four-stroke engine according to claim 1, characterized in that, said one-way valve chamber is set under the crankshaft chamber and more than one one-way valve is set in said one-way valve chamber.

4. The four-stroke engine according to claim 1, characterized in that, said mixed oil and gas is gas mixture of air, fuel and lubricating oil.
